(19) United States
(12) Patent Application Publication
(10) Pub. No.: US 2015/0054820 A1
(43) Pub. Date: Feb. 26, 2015

(54) NATURAL USER INTERFACE SYSTEM WITH CALIBRATION AND METHOD OF OPERATION THEREOF

(71) Applicant: Sony Corporation, Tokyo (JP)

(72) Inventors: Wei Ji, San Jose, CA (US); Alexander Berestov, San Jose, CA (US); Daniel Usikov, Newark, CA (US); Golnaz Abdollahian, San Jose, CA (US); Keisuke Yamaoka, Tokyo (JP); Jun Yokono, Tokyo (JP)

(21) Appl. No.: 13/973,478

(22) Filed: Aug. 22, 2013

(51) Int. Cl. G06F 3/042

(52) U.S. Cl. CPC G06F 3/0426
USPC 345/418

(57) ABSTRACT

A natural user interface system and method of operation thereof including: providing a display screen having a range camera connected to the display screen in a known location relative to the display screen; determining a user's pointing vector as pointing towards the display screen; determining the user's pointing vector as motionless; and initializing a cursor in the center of the display screen and simultaneously calibrating the user's pointing vector as an initial pointing vector pointing at the center of the display screen.

### TECHNICAL FIELD

The present invention relates generally to a natural user interface system, and more particularly to a system for calibration of the natural user interface system.

### BACKGROUND ART

To a large extent, humans' interactions with electronic devices, such as computers, tablets, and mobile phones, requires physically manipulating controls, pressing buttons, or touching screens. For example, users interact with computers via input devices, such as a keyboard and mouse. While a keyboard and mouse are effective for functions such as entering text and scrolling through documents, they are not effective for many other ways in which a user could interact with an electronic device. A user's hand holding a mouse is constrained to move only along flat two-dimensional (2D) surfaces, and navigating with a mouse through three dimensional virtual spaces is clumsy and non-intuitive. Similarly, the flat interface of a touch screen does not allow a user to convey any notion of depth.

Using three-dimensional (3D, or depth) or range cameras, gesture-based 3D control of electronic devices can be achieved. However, current methods of allowing 3D control using the user's body or hands rely on large gestures or lengthy calibration procedures.

Thus, a need still remains for a better initialization procedure for a natural user interface. In view of the changing demands of consumers, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a natural user interface system including: providing a display screen having a range camera connected to the display screen in a known location relative to the display screen; determining a user's pointing vector as pointing towards the display screen; determining the user's pointing vector as motionless; and initializing a cursor in the center of the display screen and simultaneously calibrating the user's pointing vector as an initial pointing vector pointing at the center of the display screen.

The present invention provides a natural user interface system, including: a display screen; a range camera connected to the display screen and in a known location relative to the display screen, the range camera for detecting a user's pointing vector as pointing towards the display screen; a processing unit connected to the display screen and the range camera, the processing unit including: a motion detection module for determining the user's pointing vector as motionless, and a cursor initialization module, coupled to the motion detection module, for initializing a cursor in the center of the display screen and simultaneously calibrating the user's pointing vector as an initial pointing vector pointing at the center of the display screen.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a natural user interface system with calibration in an embodiment of the present invention.

FIG. 2 is an exemplary view of the natural user interface system in a calibration phase of operation.

FIG. 3 is the exemplary view of FIG. 2 in a movement phase of operation.

FIG. 4 is a calibration flow chart detailing the calibration phase of operation of FIG. 2.

FIG. 5 is a flow chart of a method of operation of the natural user interface system with calibration in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The same numbers are used in all the drawing FIGs. to relate to the same elements. The embodiments may be numbered first embodiment, second embodiment, etc. as a matter of descriptive convenience and are not intended to have any other significance or provide limitations for the present invention.

For expository purposes, the term “horizontal” or “horizontal plane” as used herein is defined as a plane parallel to the plane or surface of the floor of the user's location. The term “vertical” or “vertical direction” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements. The term “directly on” means that there is direct contact between one element and another element without an intervening element.

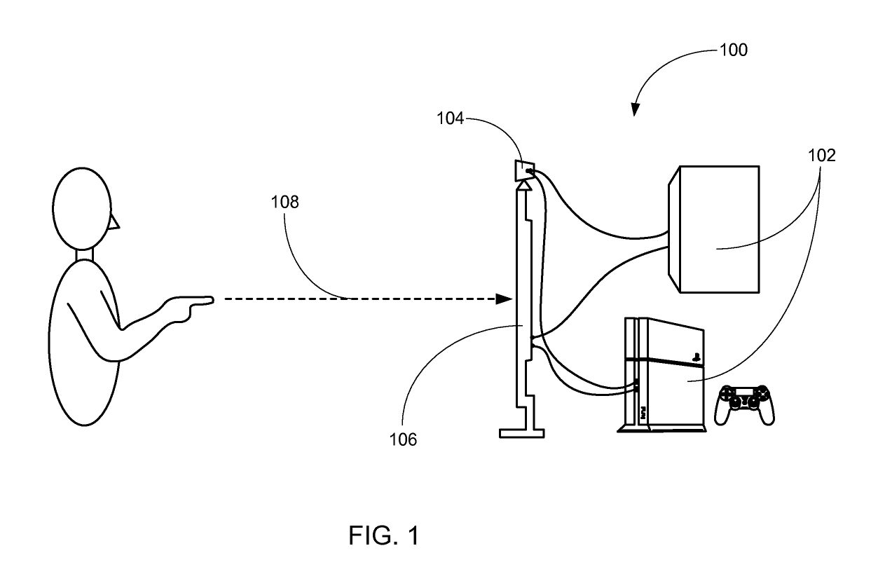

Referring now to FIG. 1, therein is shown a natural user interface system 100 with calibration in an embodiment of the present invention. The natural user interface system 100 has a processing unit 102, a range camera 104, and a display screen 106. Shown pointing towards the display screen 106 is a user and a user's pointing vector 108.

The processing unit 102 is connected to both the range camera 104 and the display screen 106. The processing unit 102 can be any of a variety of electronic devices such as a personal computer, a notebook or laptop computer, a set-top box, a digital video recorder (DVR), a Digital Living Network Alliance® (DLNA) device, a game console, an audio/video receiver, or other entertainment device. For illustrative purposes, two examples of the processing unit 102 are shown, but it is understood that only one is necessary. Connection points on the examples of the processing unit 102 are also for clarity of illustration only.

The processing unit 102 can contain many modules capable of performing various functions such as a motion detection module coupled to a vector determination module, a frame count module coupled to both the motion detection module and the vector determination module, and a cursor initialization module coupled to the frame count module. The processing unit 102 can run some or all of the modules simultaneously.

The range camera 104 is a device capable of determining distance from the camera of any given point of an image. The range camera 104 can operate using a variety of methods such as stereoscopic video capture, radar, laser scanning, interferometry, time-of-flight, or other methods for determining distance of a given point from the camera. The display screen 106 can utilize a variety of display technologies such as LCD, LED-LCD, plasma, holographic, OLED, front and rear projection, CRT, or other display technologies.

For illustrative purposes, the processing unit 102 is shown as separate from the range camera 104 and the display screen 106, but it is understood that other combinations and configurations are possible. For example, the processing unit 102 and the display screen 106 can be integrated into one device, such as a laptop computer. Also for example, the processing unit 102, the range camera 104, and the display screen 106 can be integrated into a single device such as a “smart” TV, a laptop computer, a mobile device, or an all-in-one desktop computer (a desktop computer where the processing unit 102 is integrated into the same physical housing as the display screen 106, frequently with a camera integrated into the same housing).

In this exemplary view, the user's pointing vector 108 is depicted as a dotted line, and shows the pointing direction of the user's hand, which is shown as a valid pointing hand. The user's pointing vector is aimed at or near the center of the display screen 106.

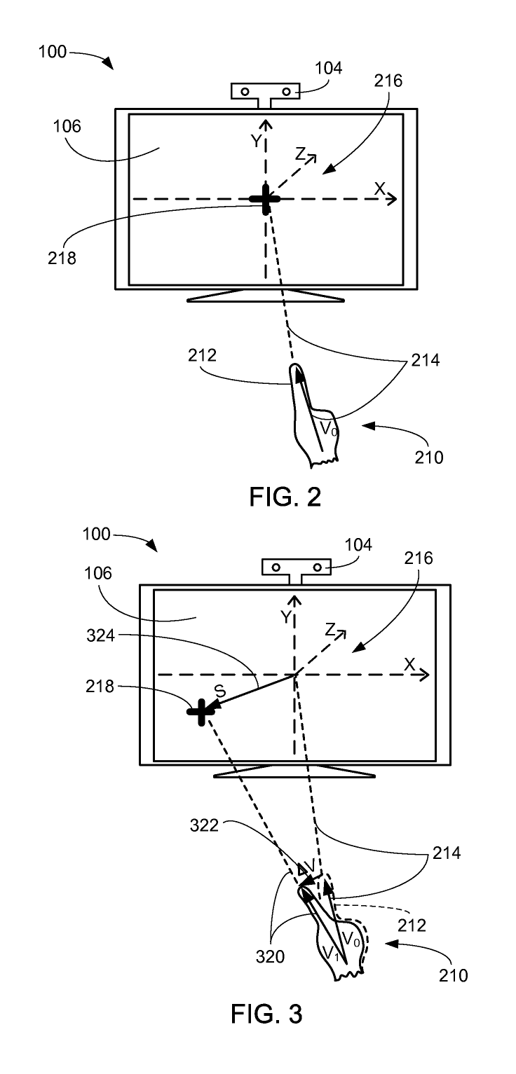

Referring now to FIG. 2, therein is shown an exemplary view of the natural user interface system 100 in a calibration phase of operation. The display screen 106 and the range camera 104 are shown, but the processing unit 102 of FIG. 1 has been omitted for clarity. A valid pointing hand 210 of a user is shown with a dotted line depicting the user's pointing vector 108. The valid pointing hand 210 can be a hand in which one finger is extended while the other fingers form a tight or relaxed fist, as an example.

The range camera 104 in conjunction with the vector determination module of the processing unit 102 can detect the valid pointing hand 210 of the user, and segment the valid pointing hand 210 to separate a pointing finger 212 (usually the index finger, but can be any finger) from the closed finger portion of the valid pointing hand 210. The pointing finger 212 and the closed finger portion can be used to generate an initial pointing vector V₀ 214, which is defined as the pointing direction of the valid pointing hand 210 in 3D space, having display coordinates 216 in x, y, and z directions. The display coordinates 216 are defined with respect to the plane of the display screen 106 facing the valid pointing hand 210 of the user. For example, x and y coordinates can be in the plane of the display screen 106 and z coordinates can be perpendicular to the plane of the display screen 106 (the z-axis is drawn as diagonal for clarity but is understood to be perpendicular to the plane of the display screen 106 in this example). The display coordinates 216 are shown with dotted lines and marked with exemplary axis labels. The display coordinates 216 shown are for example only, and can be oriented in any direction.

If the valid pointing hand 210 or the initial pointing vector V₀ 214 is detected as pointing at or near the center of the display screen 106 and remains substantially motionless for a set period of time (for example, 0.3-0.5 seconds, but it is understood that any length of time may be chosen depending on the application and needs of the user), a cursor 218 can be initialized and displayed in the center of the display screen 106. In this example, the cursor 218 is shown as a cross or plus sign, and is exaggerated for clarity, but it is understood that the cursor 218 can be any thickness or shape. Because it is unrealistic to expect any person to keep their hand perfectly still, a movement threshold value for what is considered substantially motionless can be set. For example, the movement threshold value of the valid pointing hand 210 during the initialization process can be one centimeter in any direction; this means that movement of less than one centimeter in any direction can be considered as motionless. As another example, the movement threshold value of the valid pointing hand 210 can be a distance defined by a number of pixels of the display screen 106 (such as 10, 20, or other appropriate number depending on the resolution of the display screen 106) in any direction including directions parallel to and orthogonal to the plane of the display screen 106.

The cursor 218 is initialized and calibrated simultaneously by the cursor initialization module of the processing unit 102. No separate calibration step is necessary because the initial motionless orientation of the initial pointing vector V₀ 214 of the valid pointing hand 210 is calibrated by the natural user interface system 100 to be the center of the display screen 106 where the cursor 218 is initialized. Crucially, the valid pointing hand 210 does not have to be oriented such that the initial pointing vector V₀ 214 is pointed exactly at the center of the display screen 106. It is only necessary to determine the relative movement of the initial pointing vector V₀ 214 as first calibrated in order to control the cursor 218 on the display screen 106.

It has been discovered that detecting the valid pointing hand 210 using the range camera 104 and simultaneously calibrating and initializing the cursor 218 at the center of the display screen 106 provides a better user experience than other systems which require separate calibration steps. Because the user does not have to precisely point at the center of the screen to initialize and calibrate the natural user interface system 100, a complicated or troublesome calibration step is avoided. This allows any user to easily point at the display screen of the natural user interface system 100 and nearly instantly (under a second) be able to manipulate the cursor 218 which has been calibrated to the movements of their pointing hand.

Referring now to FIG. 3, therein is shown the exemplary view of FIG. 2 in a movement phase of operation. The dotted lines show initial position of the pointing finger 212 of the valid pointing hand 210 from which the initial pointing vector V₀ 214 is generated. The following process can be operated by a cursor movement module which is coupled to the cursor initialization module.

A second pointing vector V₁ 320 is determined in the same manner as determining the initial pointing vector V₀ 214 and the second pointing vector V₁ 320 is shown a movement vector ΔV 322 away from the initial pointing vector V₀ 214. The movement vector ΔV 322 is calculated using the difference between all of the display coordinates 216 x, y, and z of the initial pointing vector V₀ 214 and the second pointing vector V₁ 320.

In order to control the cursor 218 on the display screen 106, the movement vector ΔV 322 must be converted into a cursor movement vector S 324 which is contained within the plane of the screen. This means that the x and y components of the movement vector ΔV 322 must be mapped onto the display screen 106 using the size of the display screen 106, the x and y components of the movement vector ΔV 322, the angle between the initial pointing vector V₀ 214 and the second pointing vector V₁ 320, and the distance of the valid pointing hand 210 from the display screen 106 as determined by the range camera 104 which is in a fixed location relative to the display screen 106. Alternatively, if the range camera 104 is movable, a separate determination of location relative to the display screen 106 is necessary.

For example, the x and y components of the difference in the display coordinates 216 of the movement vector ΔV 322 can be isolated from the start and end of the display coordinates 216 of the movement vector ΔV 322. The z component of the movement vector ΔV 322 can be used separately to determine, for example, if a button depicted on the display screen 106 has been “pushed.” The x and y components of the movement vector ΔV 322 can be mapped onto the display screen 106 as the cursor movement vector S 324 by transforming with a conversion gain which is dependent on the size of the display screen 106 and the distance of the valid pointing hand 210 from the display screen 106. The conversion gain can be dynamically adjusted as the distance of the valid pointing hand 210 from the display screen 106 changes.

Continuing the example, using the distance of the valid pointing hand 210 from the display screen 106, the x and y components of the movement vector ΔV 322, and the known size of the display screen 106, the cursor movement vector S 324 can be easily calculated. In this way, movements of the valid pointing hand 210 of the user can be mapped to movements of the cursor 218 on the display screen 106.

It has been discovered that controlling the cursor 218 on the display screen 106 using relative movements as captured in the movement vector ΔV 322 rather than exact pointing vectors provides a more natural and comfortable experience for an end user. It has been found that in practice, users are not concerned about their fingers pointing exactly at the cursor 218 on the display screen 106 so long as the cursor 218 moves in a way that matches up with the movements of their hands. Because the movement vector ΔV 322 captures the relative movement of the valid pointing hand 210, and the natural user interface system 100 is initially calibrated at the center of the display screen 106 regardless of the exact point where the initial pointing vector V₀ 214 intersects the display screen 106, users are able to move and point their fingers in a way most comfortable for them; whether standing up, sitting down, or even in a crowded environment.

It has also been discovered that controlling the cursor 218 on the display screen 106 using only measurements of the valid pointing hand 210 using the range camera 104 provides a more comfortable and less tiring natural interface for the user. Unlike other gesture based systems, the natural user interface system 100 does not require large movements of the user's body. Further, because there is no requirement that the user be a particular distance from the display screen 106 or the range camera 104, the natural user interface system 100 can be used easily at an arbitrary distance. For example, the natural user interface system 100 can be used at common television usage ranges such as 0.8 to 2.5 meters. It is understood that a much larger or shorter range is possible depending on the type of gesture or application and specifications of the range camera 104.

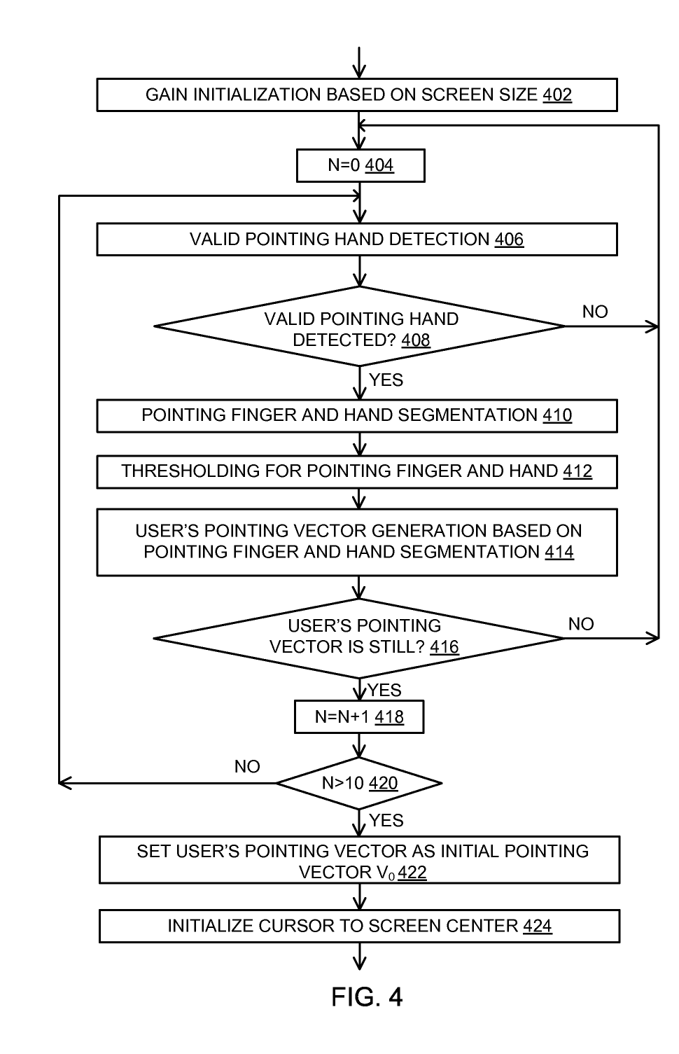

Referring now to FIG. 4, therein is shown a calibration flow chart 400 detailing the calibration phase of operation of FIG. 2. Beginning with step 402, the natural user interface system 100 is initialized by determining or reading the size of the display screen 106 of FIG. 2, which is combined later with a distance reading from the range camera 104 of FIG. 1 to calculate the gain in movement of the cursor 218 of FIG. 2 on the display screen 106 once the movement vector ΔV 322 of FIG. 3 is determined.

At step 404, the number of frames in which the valid pointing hand 210 of FIG. 2 is detected (a frame count represented by N) as still or not moving by the range camera 104 is set to zero by the frame count module of the processing unit 102 of FIG. 1. For example, the range camera 104 can capture images at 30 frames per second (fps), 60 fps, 120 fps, or at an intermediate capture rate.

At step 406, the range camera 104 in conjunction with the processing unit 102 of FIG. 1 determines if the valid pointing hand 210 is detected in a current captured frame. At decision box 408, if the valid pointing hand 210 is not detected by the vector determination module of the processing unit 102, the process goes back to step 404 where the frame count is set to zero and the calibration phase begins again. If the valid pointing hand 210 is detected, the calibration phase proceeds to step 410. At step 410, once the valid pointing hand 210 is detected, the pointing finger 212 and the closed finger portion are segmented for later processing.

At step 412, the pointing finger 212 of FIG. 2 (usually the index finger) and closed finger portions undergo thresholding before generating the user's pointing vector 108 of FIG. 1. At step 414, the user's pointing vector 108 is generated from the orientations of the pointing finger 212 and the closed finger portion of the valid pointing hand 210 by the vector determination module of the processing unit 102. The user's pointing vector 108 is determined mostly by the orientation of the length of the pointing finger 212.

Upon generating the user's pointing vector 108, another current frame is captured by the range camera 104 and is analyzed to check if the user's pointing vector 108 is moving or not moving by comparing the another current frame to the current captured frame, which is considered a previous frame after the capture of the another current frame. At decision box 416, if the user's pointing vector 108 is determined to be moving, the process returns to step 404, and the frame count is reset to zero. If the user's pointing vector 108 is, instead, determined to be still or motionless in the next captured frame from the range camera 104, the calibration phase proceeds to step 418. For example, to be considered motionless, the user's pointing vector 108 can move no more than the movement threshold value in any direction such as 5 mm, 1 cm, or other suitable distance to account for natural hand movement. The movement threshold value is necessary because it is unrealistic to expect any user to hold their hand perfectly still.

At step 418, the frame count is incremented by one (N=N+1) by the frame count module of the processing unit 102 and the calibration phase proceeds to step 420. At step 420, a check is made to see whether the frame count has reached a frame count threshold value. In this example, the frame count threshold value is 10 frames of the user's pointing vector 108 being still. To continue the example, if the range camera 104 is running at 30 fps, 10 frames will take approximately 0.33 seconds to capture. As another example, if the range camera is running at 60 fps, 10 frames will take about 0.17 seconds to capture. The frame count threshold value can be adjusted as necessary to avoid false positive or false negative detection. An optional feature can be to allow the user to adjust the frame count threshold value or the capture rate of the range camera 104.

It has been discovered that the frame count threshold value being adjustable allows for fine-tuned detection of when a user wants to initialize and calibrate the natural user interface system 100. For example, if 10 frames at 60 fps to initialize in 0.17 seconds is found to generate too many false positives which could cause the cursor 218 to initialize and be calibrated when it is unwanted, the frame count threshold value can be adjusted to a minimum value that allows for quick detection without false positives such as 20 frames at 60 fps in about 0.34 seconds. Alternatively, the capture rate of the range camera 104 can be adjusted to obtain an optimal value to avoid making the user wait too long and giving up.

In the preceding example, the frame count threshold value is set at N>10 or N=11. If the frame count threshold value is not reached, the process returns to step 406 to detect the valid pointing hand 210 again. In this situation, the frame count is not reset to 0, which only happens in step 404. The frame count is incremented each time until the frame count threshold value is reached or the user's pointing vector 108 is detected as moving. If the frame count threshold value is reached, the user's pointing vector 108 captured to reach the frame count threshold value is set as the initial pointing vector V₀ 214 of FIG. 2 at step 422.

At step 424, the cursor 218 is initialized in the center of the display screen 106 and the initial pointing vector V₀ 214 is considered to be calibrated to the same point, even if it is not pointing exactly at the center of the display screen 106. The distance reading of the pointing finger 212 from the range camera 104 is combined with the previously determined size of the display screen 106 to determine the necessary gain to translate the movement vector ΔV 322 of FIG. 3 of the valid pointing hand 210 to the cursor movement vector S 324 of FIG. 3 on the display screen 106.

It has been discovered that setting the initial pointing vector V₀ 214 after a low threshold of, for example, 10 frames, and allowing simultaneous initialization and calibration of the cursor 218 to the center of the display screen in less than one second greatly enhances the user experience. The natural user interface system 100 is set up such that the initialization and calibration steps are easy and nearly transparent to the user as they can be completed in the time interval of, for example, 0.3 seconds, without the necessity for the user to go through a lengthy calibration process such as pointing at the corners of the screen. From a user's perspective, initialization and calibration that takes less than one second is nearly instantaneous and can lead to natural use of the cursor at any time.

Thus, it has been discovered that the natural user interface system 100 and method of operation thereof of the present invention furnishes important and heretofore unknown and unavailable solutions, capabilities, and functional aspects for simply and easily allowing users to control a user interface using natural pointing gestures.

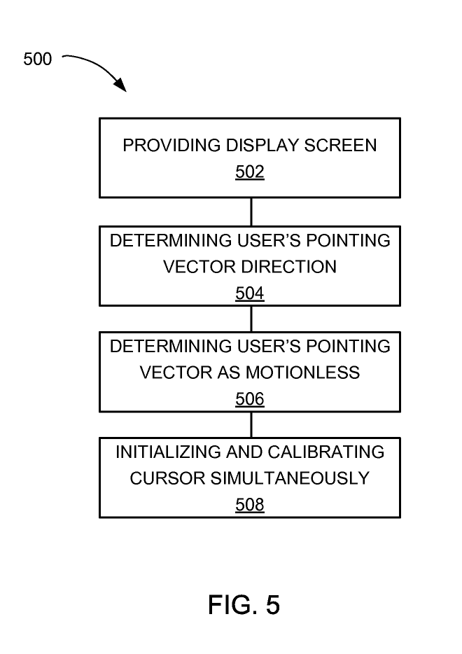

Referring now to FIG. 5, therein is shown a flow chart of a method 500 of operation of the natural user interface system 100 with calibration in a further embodiment of the present invention. The method 500 includes: providing a display screen having a range camera connected to the display screen in a known location relative to the display screen in a block 502; determining a user's pointing vector as pointing towards the display screen in a block 504; determining the user's pointing vector as motionless in a block 506; and initializing a cursor in the center of the display screen and simultaneously calibrating the user's pointing vector as an initial pointing vector pointing at the center of the display screen in a block 508.

The resulting method, process, apparatus, device, product, and/or system is straightforward, cost-effective, uncomplicated, highly versatile and effective, can be surprisingly and unobviously implemented by adapting known technologies, and are thus readily suited for efficiently and economically manufacturing natural user interface systems/fully compatible with conventional manufacturing methods or processes and technologies.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a natural user interface system comprising:
providing a display screen having a range camera connected to the display screen in a known location relative to the display screen;
determining a user's pointing vector as pointing towards the display screen;
determining the user's pointing vector as motionless; and
initializing a cursor in the center of the display screen and simultaneously calibrating the user's pointing vector as an initial pointing vector pointing at the center of the display screen.

2. The method as claimed in claim 1 further comprising providing a processing unit connected between the display screen and the range camera.

3. The method as claimed in claim 1 further comprising:
detecting a valid pointing hand; and
determining the user's pointing vector from the orientation of the valid pointing hand.

4. The method as claimed in claim 1 wherein determining the user's pointing vector as motionless includes:
setting a movement threshold value of the user's pointing vector; and
determining movement of the user's pointing vector as less than the movement threshold value.

5. The method as claimed in claim 1 further comprising:
mapping the initial pointing vector to display coordinates of the display screen;
determining a second pointing vector;
mapping the second pointing vector to the display coordinates; and
determining a movement vector ΔV by determining the difference between the display coordinates of the initial pointing vector and the second pointing vector.

6. A method of operation of a natural user interface system comprising:
providing a display screen connected to a processing unit connected to a range camera in a known location relative to the display screen;
detecting a valid pointing hand;
determining a user's pointing vector of the valid pointing hand as pointing towards the display screen;
determining the user's pointing vector as motionless;
initializing a cursor in the center of the display screen and simultaneously calibrating the user's pointing vector as an initial pointing vector pointing at the center of the display screen;
mapping the initial pointing vector to display coordinates of the display screen;
determining a second pointing vector of the valid pointing hand;
mapping the second pointing vector to the display coordinates; and
determining a movement vector ΔV by determining the difference between the display coordinates of the initial pointing vector and the second pointing vector.

7. The method as claimed in claim 6 further comprising:
determining a distance of the valid pointing hand from the display screen;
setting a conversion gain based on the size of the display screen and the distance of the valid pointing hand from the display screen;
transforming the movement vector ΔV into a cursor movement vector S using the conversion gain; and
moving the cursor on the display screen using the cursor movement vector S.

8. The method as claimed in claim 6 wherein determining the user's pointing vector of the valid pointing hand includes:
segmenting the valid pointing hand into a pointing finger and a closed finger portion;
thresholding the pointing finger and the closed finger portion; and
generating the user's pointing vector based on an orientation of the pointing finger and the closed finger portion.

9. The method as claimed in claim 6 wherein determining the user's pointing vector as motionless includes:
setting a frame count to zero;
setting a frame count threshold value;
capturing a previous frame and a current frame with the range camera;
setting a movement threshold value of the user's pointing vector;
incrementing the frame count by one when the current frame compared to the previous frame has movement less than the movement threshold value, or resetting the frame count to zero when the current frame compared to the previous frame has movement more than the movement threshold value; and
capturing another current frame with the range camera until the frame count reaches the frame count threshold value.

10. The method as claimed in claim 6 wherein providing the display screen includes providing the display screen, the range camera, and the processing unit in a single physical housing.

11. A natural user interface system comprising:
a display screen;
a range camera connected to the display screen and in a known location relative to the display screen, the range camera for determining a user's pointing vector as pointing towards the display screen;
a processing unit connected to the display screen and the range camera, the processing unit including:
a motion detection module for determining the user's pointing vector as motionless, and
a cursor initialization module, coupled to the motion detection module, for initializing a cursor in the center of the display screen and simultaneously calibrating the user's pointing vector as an initial pointing vector pointing at the center of the display screen.

12. The system as claimed in claim 11 wherein the processing unit is connected between the display screen and the range camera.

13. The system as claimed in claim 11 wherein:
the range camera is for detecting a valid pointing hand; and
the processing unit includes a vector determination module, coupled to the motion detection module, for determining the user's pointing vector from the orientation of the valid pointing hand.

14. The system as claimed in claim 11 wherein:
the processing unit is for setting a movement threshold value of the user's pointing vector; and
the range camera is for determining movement of the user's pointing vector as less than the movement threshold value.

15. The system as claimed in claim 11 wherein the processing unit is for:
mapping the initial pointing vector to display coordinates of the display screen;
determining a second pointing vector;
mapping the second pointing vector to the display coordinates; and
determining a movement vector ΔV by determining the difference between the display coordinates of the initial pointing vector and the second pointing vector.

16. The system as claimed in claim 11 wherein:
the range camera is for detecting a valid pointing hand;
the processing unit is connected between the display screen and the range camera, the processing unit including:
a vector determination module, coupled to the motion detection module, for determining the user's pointing vector from the orientation of the valid pointing hand, and
a cursor movement module, coupled to the cursor initialization module, for:
mapping the initial pointing vector to display coordinates of the display screen,
determining a second pointing vector of the valid pointing hand,
mapping the second pointing vector to the display coordinates, and
determining a movement vector ΔV by determining the difference between the display coordinates of the initial pointing vector and the second pointing vector.

17. The system as claimed in claim 16 wherein:
the range camera is for determining a distance of the valid pointing hand from the display screen;
the processing unit is for:
setting a conversion gain based on the size of the display screen and the distance of the valid pointing hand from the display screen,
transforming the movement vector ΔV into a cursor movement vector S using the conversion gain, and
moving the cursor on the display screen using the cursor movement vector S; and
the display screen is for displaying the cursor moving on the display screen.

18. The system as claimed in claim 16 wherein the vector determination module of the processing unit is for:
segmenting the valid pointing hand into a pointing finger and a closed finger portion;
thresholding the pointing finger and the closed finger portion; and
generating the user's pointing vector based on an orientation of the pointing finger and the closed finger portion.

19. The system as claimed in claim 16 wherein the processing unit includes:
a frame count module, coupled to the motion detection module and the vector determination module, for:
setting a frame count to zero;
setting a frame count threshold value;
capturing a previous frame and a current frame with the range camera;
setting a movement threshold value of the user's pointing vector;
incrementing the frame count by one when the current frame compared to the previous frame has movement less than the movement threshold value, or resetting the frame count to zero when the current frame compared to the previous frame has movement more than the movement threshold value; and
capturing another current frame with the range camera until the frame count reaches the frame count threshold value.

20. The system as claimed in claim 16 wherein the display screen, the range camera, and the processing unit are contained in a single physical housing.
